(19) United States
(12) Patent Application Publication
(10) Pub. No.: US 2026/0229257 A1
(43) Pub. Date: Aug. 6, 2026

(54) Cationic Multimetallic Transition Metal Complexes Salts As Oxygen Releaser In Hard Disk Drives

(71) Applicant: Western Digital Technologies, Inc., San Jose, CA (US)

(72) Inventors: Ruihua LI, Cupertino, CA (US); Dan-hui Dorothy YANG, Sunnyvale, CA (US); Guang LI, Cupertino, CA (US); David DUDEK, San Jose, CA (US); Qing DAI, San Jose, CA (US); Chun ZHOU, San Jose, CA (US)

(73) Assignee: Western Digital Technologies, Inc., San Jose, CA (US)

(21) Appl. No.: 19/047,058

(22) Filed: Feb. 6, 2025

(51) Int. Cl. G11B 33/14; C07F 1/08; C07F 13/00; C07F 15/02; C07F 15/04; C07F 15/06

(52) U.S. Cl. CPC G11B 33/1446; C07F 1/08; C07F 13/005; C07F 15/025; C07F 15/045; C07F 15/065

(57) ABSTRACT

The present disclosure is generally directed towards a data storage device comprising a crystalline salt configured to release oxygen. The crystalline salt comprises a cation and a counteranion. The counteranion may be selected from the group consisting of: ClO₄—, PF₆—, BF₄—, CF₃SO₃—, and NO₃—. In one embodiment, the cation is ([(2-pyridylmethyl)aminomethyl)-4-tert-butylphenolato)M₂(O₂)(R1)ₘ]^{2m+})ₙ, where M is selected from the group consisting of: Co, Ni, Mn, Fe, and Cu, and R1 is caboxylated and selected from the electron donating or drawing group consisting of: F, Cl, Br, I, carbonyl, carboxyl, hydroxyl, alkyl, aryl, amine, amide, and nitro. In the cation, n is a numeral between 0 and 4, and m is a numeral between 1 and 100, where m represents the number of repeating units of the cation. The crystalline salt is configured to release oxygen above about 30° C. to maintain a level of about 8% to about 12% of oxygen.

### BACKGROUND OF THE DISCLOSURE

### Field of the Disclosure

Embodiments of the present disclosure generally relate to a data storage device comprising cationic multimetallic transition metal complexes salts.

### Description of the Related Art

Data storage systems are used to store large amounts of information. A data storage system typically includes a read/write transducer for retrieving and storing information. Some data storage systems use rotating storage devices, such as rotating optical devices (e.g., CD and DVD drives) or hard disk drives containing rotating magnetic disks (also referred to as platters or media). In some such data storage systems, a suspended slider supports a head that includes the read/write transducer. The slider provides mechanical support for the head and the electrical connections between the head and the rest of the data storage system.

When the data storage system is in operation, the slider floats a small distance above the recording medium (e.g., a hard disk in a hard disk drive), which rotates at high speeds. Components of the data storage system move the slider and, therefore, the head to a desired radial position over the surface of the rotating medium, and the head reads or writes information. The slider rides on a cushion or bearing of air or gas created above the surface of the medium as the disk rotates at its operating speed. The slider has an air-bearing surface (ABS) or media facing surface (MFS) that faces the medium. The MFS is designed to generate an air-bearing force that counteracts a preload bias that pushes the slider toward the medium. The MFS causes the slider to fly above and out of contact with the medium.

Higher storage bit densities in magnetic media used in disk drives have reduced the size (volume) of data cells to the point where the cell dimensions are limited by the grain size of the magnetic material. Although grain size can be reduced further, the data stored within the cells may not be thermally stable. That is, random thermal fluctuations at ambient temperatures may be sufficient to erase data. This state is described as the superparamagnetic limit, which determines the maximum theoretical storage density for a given magnetic media. This limit may be raised by increasing the coercivity of the magnetic media or by lowering the temperature. Lowering the temperature may not always be practical when designing hard disk drives for commercial and consumer use. Raising the coercivity, on the other hand, may result in a need for write heads that incorporate higher magnetic moment materials, or techniques such as perpendicular recording (or both).

Another solution uses heat to lower the effective coercivity of a localized region on the magnetic media surface and writes data within this heated region. The data state becomes “fixed” upon cooling the media to ambient temperatures. This technique is broadly referred to as “thermally assisted (magnetic) recording” (TAR or TAMR), “energy assisted magnetic recording” (EAMR), or “heat-assisted magnetic recording” (HAMR). The term “HAMR” is used herein to refer to all of TAR, TAMR, EAMR, and HAMR.

In HAMR, a magnetic recording material with high magneto-crystalline anisotropy (Ku) is heated locally during writing to lower the coercivity enough for writing to occur, but the coercivity/anisotropy is high enough that the recorded bits are thermally stable at the ambient temperature of the disk drive (i.e., the normal operating or “room” temperature of approximately 15-30 degrees Celsius). In some proposed HAMR systems, the magnetic recording material is heated to near or above its Curie temperature. The recorded data may then be read back at ambient temperature by a conventional magnetoresistive read head. HAMR disk drives have been proposed for both conventional continuous media, wherein the magnetic recording material is a continuous layer on the disk, and for bit-patterned media (BPM), in which the magnetic recording material is patterned into discrete data islands or “bits.”

One type of HAMR data storage device uses a laser source and an optical waveguide coupled to a near-field transducer (NFT) for heating the recording material on the media. A “near-field” transducer refers to “near-field optics,” wherein light is passed through a first element with subwavelength features and the light is coupled to a second element, such as a substrate (e.g., of a magnetic recording medium), located a subwavelength distance from the first element. The NFT is typically located at the air-bearing surface (ABS) of an air-bearing slider that also supports the read/write head and rides or “flies” above the media surface. An NFT may have a generally triangular output end, such that an evanescent wave generated at a surface of the waveguide couples to surface plasmons excited on the surface of the NFT, and a strong optical near-field is generated at the apex of the triangular output end.

One potential issue with HAMR devices is that excessive heating of the NFT can cause performance degradation and eventually failure of the data storage device. One possible cause of failure due to excessive heating may be due to adsorption of carbonaceous material on the slider overcoat near the NFT tip. Hydrocarbon molecules from the recording media overcoat and lubricant can become mobile at elevated temperatures and adsorb on the ABS of the slider. Over time, these molecules can form a “smear” that absorbs power from the laser source and causes the NFT, which normally operates at very high temperatures, to become even hotter than usual. The heat transfer can result in diffusion of the NFT metal until the NFT tip rounds and recording degrades, eventually possibly leading to failure of the data storage device.

Smear can contain materials such as carbon, silicon, and/or nitrogen. Consequently, if the smear is hot enough while in the presence of enough oxygen, it can oxidize and produce glassy products (e.g., materials that have amorphous, non-crystalline structures similar to that of glass, such as, e.g., SiO₂, etc.) and/or carbon-based and nitrogen-based gases (e.g., CO, CO₂, NO, NO₂, etc.), or combinations thereof. The produced gases dissipate, and the HAMR head's laser light can typically penetrate the resulting glassy products (if present) without heating them, which provides the desired heating of the recording media while preventing excessive heating of the NFT, which can substantially improve the lifetime of the NFT. This oxidation process consumes oxygen molecules inside of the data storage device.

Many older data storage devices operate in a standard air (e.g., nitrogen, oxygen, and water vapor mixture) atmosphere. Spinning recording media in hard disk drives at high revolutions per minute against the friction of an air atmosphere is largely inefficient and requires a certain amount of power. To address this inefficiency, a data storage device can be filled at least partially with a lower-density gas, such as helium or hydrogen, and sealed to control and maintain the internal environment of the data storage device. Sealing mitigates or prevents leakage of internal gases from within the data storage device. The use of helium, which has a density that is approximately one-seventh that of air, reduces friction and vibration in the data storage device, thereby creating less drag and turbulence. Consequently, by running the data storage device in a less-dense atmosphere, such as an atmosphere of helium or a mixture of helium and oxygen, friction on the recording media is reduced, thereby causing the recording media to require less power in order to spin at a similar rate as the recording media in data storage devices that operate in standard air conditions. The use of helium generally also reduces the operating temperature of the data storage device, as well as the amount of noise it generates.

Smear is common in data storage devices that are sealed and contain helium, because there are far fewer oxygen molecules in such devices than in standard-atmosphere data storage devices. One side-effect of the (desirable) oxidation of smear in a sealed data storage device is that it consumes oxygen molecules sealed within the interior of the data storage device, which reduces the number of oxygen molecules available for oxidation as the data storage device ages. In addition to the oxidation of smear, other components in data storage devices can consume oxygen via oxidation (e.g., platter surface oxidation, connector and/or interface oxidation, PCB oxidation, head and/or actuator oxidation, etc.). As a result, the quantity of oxygen molecules available may eventually be insufficient to promote oxidation of the smear, which can cause the data storage device to fail. The loss rate of oxygen also tends to be exacerbated as the temperature of the data storage device increases.

Therefore, there is a need for improvements.

### SUMMARY OF THE DISCLOSURE

Oxygen (O₂) is a gas that is consumed by a data storage device when the data storage device is heated above room temperature, such as a temperature of about 25° C. or higher. Crystalline salts of cationic multimetallic transition metal complexes are oxygen releasing substances that can be utilized in the data storage device to generate oxygen in order to replace the oxygen that has been consumed. By utilizing such a crystalline salt, the amount of oxygen within a data storage device can be regulated as needed, such as to maintain a level of oxygen of about 8% to about 12% of the atmosphere within the data storage device. Such crystalline salts can both absorb and desorb oxygen to maintain a constant level of oxygen within the data storage device. By regulating the amount of oxygen within the data storage device, the data storage device has a higher reliability and lifetime.

The present disclosure is generally directed towards a data storage device comprising a crystalline salt configured to release oxygen. The crystalline salt comprises a transition metal cation and a counteranion. The counteranion may be selected from the group consisting of: perchlorate (ClO₄—), tetrafluoroborate (PF₆—), hexafluorophosphate (BF₄—), trifluoromethanesulfonate (CF₃SO₃—), sulfate, halides, chloride, bromide, fluoride, iodide, astatine, nitrate, thiocyanate, acetate, carbonate, selenite, oxalate, phosphate, thiosulfate, silicate, metasilicate, chromate, dichromate, permanganate, citrate, cyanide, nitrite, chlorate, antimonite hexachloro-antimonate, hexafluoro antimonate, arsenate, arsenite, molybdenum, hexafluorosilicate, and aluminate.

In one embodiment, the cation is ([(2-pyridylmethyl)aminomethyl)-4-tert-butylphenolato)M₂(O₂)(R1-COOH)ₘ]^{2m+})ₙ, where M is selected from the group consisting of: Co, Ni, Mn, Fe, and Cu, and where R1-COOH is selected from the group consisting of: methyl, phenyl, choloromethyl, dicholoromethyl, tricholoromethyl, ethylsulfide, a polymer comprising carboxyl repeating units, 1,4-dicarboxyl benzene, 1,3-dicarboxyl benzene, 1,2-dicarboxyl benzene, 1,3,5-tricarboxyl benzene, naphthalene comprising 3 carboxyl groups, and anthracene comprising 3 carboxyl groups, and wherein 1,4-dicarboxyl benzene, 1,3-dicarboxyl benzene, 1,2-dicarboxyl benzene, 1,3,5-tricarboxyl benzene, naphthalene, and anthracene, which can be substituted or non-substituted. R1-COOH can be tuned by the substitutions on the basic framework using electron donating or withdrawing groups, n is a numeral between 0 and 4, and m is a numeral between 1 and 100 or more, where m is determined by the number of carboxyl groups in a molecule or a polymer containing carboxyl repeating unit. Some typical examples can be 1,4-dicarboxyl benzene, 1,3-dicarboxyl benzene, 1,3,5-tricarboxyl benzene and the like. The electron donating group or withdrawing group can be F, Cl, Br, I, carbonyl, carboxyl, hydroxyl, alkyl, aryl, amine, amide, nitro, and so on. Optional groups R2/R3/R4 can be substitutions on pyridyl and phenyl rings, and can be independently electron withdrawing or electron donating groups to tune the oxygen releasing properties. The optional groups R2/R3/R4 can be selected from F, Cl, Br, I, carbonyl, carboxyl, hydroxyl, alkyl, aryl, amine, amide, nitro, or an electron donating group or an electron withdrawing group. The crystalline salt is configured to release oxygen at elevated temperature, such as above about 40° C. to maintain a level of about 8% to about 12% of oxygen within the device.

In one embodiment, a data storage device comprises a crystalline salt of cationic multimetallic transition metal complexes configured to release oxygen, the crystalline salt of cationic multimetallic transition metal complexes comprising: a counteranion selected from the group consisting of: perchlorate (ClO₄—), tetrafluoroborate (PF₆—), hexafluorophosphate (BF₄—), trifluoromethanesulfonate (CF₃SO₃—), sulfate, halides, chloride, bromide, fluoride, iodide, astatine nitrate, thiocyanate, acetate, carbonate, selenite, oxalate, phosphate, thiosulfate, silicate, metasilicate, chromate, dichromate, permanganate, citrate, cyanide, nitrite, chlorate, antimonite hexachloro-antimonate, hexafluoro antimonate, arsenate, arsenite, molybdenum, hexafluorosilicate, and aluminate; and structure 1:

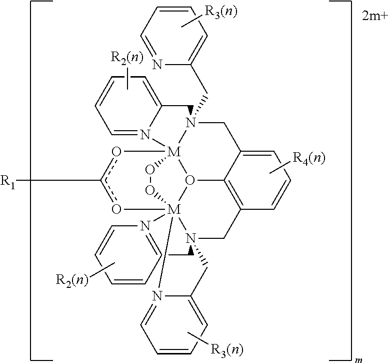

wherein M is selected from the group consisting of: Co, Ni, Mn, Fe, and Cu, wherein n is a numeral between 1 and 4, and wherein m is a numeral between 1 and 100, m being the number of repeating units of structure 1.

In another embodiment, an oxygenating material for treating an atmosphere of a magnetic storage device, the oxygenating material comprises a counteranion selected from the group consisting of: perchlorate (ClO₄—), tetrafluoroborate (PF₆—), hexafluorophosphate (BF₄—), trifluoromethanesulfonate (CF₃SO₃—), sulfate, halides, chloride, bromide, fluoride, iodide, astatine, nitrate, thiocyanate, acetate, carbonate, selenite, oxalate, phosphate, thiosulfate, silicate, metasilicate, chromate, dichromate, permanganate, citrate, cyanide, nitrite, chlorate, antimonite hexachloro-antimonate, hexafluoro antimonate, arsenate, arsenite, molybdenum, hexafluorosilicate, and aluminate; and structure 1:

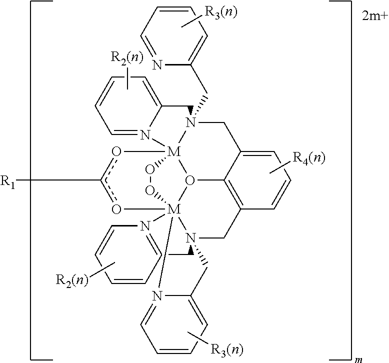

wherein M is selected from the group consisting of: Co, Ni, Mn, Fe, and Cu, wherein n is a numeral between 0 and 4, wherein m is a numeral between 1 and 100, m being the number of repeating units of structure 1, wherein R1-COOH is selected from the group consisting of: methyl, phenyl, choloromethyl, dicholoromethyl, tricholoromethyl, ethylsulfide, a polymer comprising carboxyl repeating units, 1,4-dicarboxyl benzene, 1,3-dicarboxyl benzene, 1,2-dicarboxyl benzene, 1,3,5-tricarboxyl benzene, naphthalene comprising 3 carboxyl groups, and anthracene comprising 3 carboxyl groups, and wherein 1,4-dicarboxyl benzene, 1,3-dicarboxyl benzene, 1,2-dicarboxyl benzene, 1,3,5-tricarboxyl benzene, naphthalene, and anthracene can be substituted or non-substituted.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1A is a top view of an example of a data storage device into which embodiments disclosed herein can be incorporated.

FIG. 1B is a side schematic view of the slider and magnetic recording medium of FIG. 1A in accordance with one aspect of the disclosure.

FIG. 2 is a plot illustrating general trends of gas consumption by a sealed data storage device as it operates.

FIG. 3 illustrates a graph illustrating the release of oxygen over time when the data storage device of FIG. 1A comprising a crystalline salt is heated and cooled, according to one embodiment.

FIG. 4 illustrates a graph showing the effect the counteranions of the crystalline salt have on oxygen releasing temperature, according to one embodiment.

FIG. 5 illustrates a graph showing the effect the R1 group of a crystalline salt has on oxygen releasing temperature, according to one embodiment.

FIG. 6 is a schematic diagram of the oxygenation module/cell, which corresponds to the oxygenation/module cell depicted in the perspective view of the HDD of FIG. 1A, according to one embodiment.

FIG. 7 is a schematic diagram of an oxygenation module, which corresponds to the oxygenation/module cell depicted in the perspective view of the HDD of FIG. 1A, according to another embodiment.

FIG. 8 is a schematic diagram of another design of an oxygenation module, which corresponds to the oxygenation/module cell depicted in the perspective view of the HDD of FIG. 1A, according to yet another embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

The present disclosure is generally directed towards a data storage device comprising a crystalline salt of cationic multimetallic transition metal complexes configured to release oxygen. The crystalline salt of cationic multimetallic transition metal complexes comprises a cation and a counteranion. The counteranion may be selected from the group consisting of: perchlorate (ClO₄—), tetrafluoroborate (BF₄—), hexafluorophosphate (PF₆—), trifluoromethanesulfonate (CF₃SO₃—), sulfate, halides, chloride, bromide, fluoride, iodide, astatine, nitrate, thiocyanate, acetate, carbonate, selenite, oxalate, phosphate, thiosulfate, silicate, metasilicate, chromate, dichromate, permanganate, citrate, cyanide, nitrite, chlorate, antimonite hexachloro-antimonate, hexafluoro antimonate, arsenate, arsenite, molybdenum, hexafluorosilicate, and aluminate. In one embodiment, the cation is ([(2-pyridylmethyl)aminomethyl)-4-tert-butylphenolato)M₂(O₂)(R1-COOH)ₘ]^{2m+})ₙ, where M is selected from the group consisting of: Co, Ni, Mn, Fe, and Cu, and where R1-COOH is selected from the group consisting of: methyl, phenyl, choloromethyl, dicholoromethyl, tricholoromethyl, ethylsulfide, a polymer comprising carboxyl repeating units, 1,4-dicarboxyl benzene, 1,3-dicarboxyl benzene, 1,2-dicarboxyl benzene, 1,3,5-tricarboxyl benzene, naphthalene comprising 3 carboxyl groups, and anthracene comprising 3 carboxyl groups, and wherein 1,4-dicarboxyl benzene, 1,3-dicarboxyl benzene, 1,2-dicarboxyl benzene, 1,3,5-tricarboxyl benzene, naphthalene, and anthracene, which can be substituted or non-substituted. R1-COOH can be tuned by the substitutions on R1 using electron donating or withdrawing groups. The electron donating group or withdrawing group can be H, F, Cl, Br, I, carbonyl, hydroxyl, alkyl, aryl, amine, amide, nitro, and so on. R2/R3/R4 are independently F, Cl, Br, I, carbonyl, hydroxyl, alkyl, aryl, amine, amide, nitro, or an electron donating group or an electron withdrawing group. In the cation, n is a numeral between 1 and 4, and m is a numeral between 1 and 100 or more, where m represents the number of repeating units of the cation. The crystalline salt is configured to release oxygen above about 40° C. to maintain a level of about 8% to about 12% of oxygen within the device.

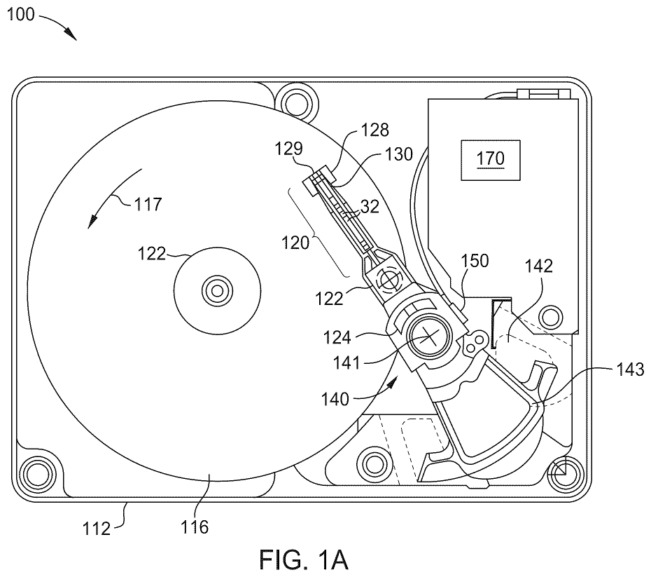

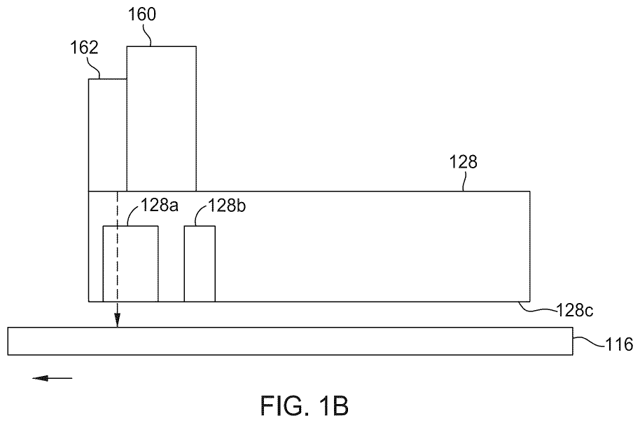

FIG. 1A is a top view of an example of a data storage device 100 (e.g., a HAMR data storage device or another type of data storage device) into which embodiments disclosed herein can be incorporated. FIG. 1A illustrates a head/disk assembly of the data storage device 100 with the cover removed. The data storage device 100 includes a rigid base 112 supporting a spindle 114 that supports a recording media 116 (or multiple recording media 116). The spindle 114 is rotated by a spindle motor (see FIG. 2), which, in operation, rotates the recording media 116 in the direction shown by the curved arrow 117. The data storage device 100 has at least one load beam assembly 120 having an integrated lead suspension (ILS) or flexure 130 with an array 32 of electrically conductive interconnect traces or lines. The at least one load beam assembly 120 is attached to rigid arms 122 connected to an E-shaped support structure, sometimes called an E-block 124. The flexure 130 is attached to a slider 128, which is typically formed of a composite material, such as a composite of alumina/titanium-carbide (Al2O3/TiC).

A recording head 129 for recording to a recording media 116 is located at the end or trailing surface of the slider 128. The recording head 129 comprises a read portion for reading from the recording media 116 and a write portion for writing to the recording media 116. FIG. 1A illustrates only one recording media 116 surface with the slider 128 and recording head 129, but there may be multiple recording media 116 stacked on a hub that is rotated by the spindle motor, with a separate slider 128 and recording head 129 associated with each surface of each recording media 116.

As the recording media 116 rotates, the recording media 116 drags gas (which may be air, helium, etc.) under the slider 128 in a direction approximately parallel to the tangential velocity of the recording media 116. The slider 128 has a media-facing air-bearing surface (ABS) or a media facing surface (MFS) that causes the slider 128 to ride on a cushion or bearing of gas, typically air, mostly helium, or hydrogen, generated by rotation of the recording media 116. (It is to be understood that the term “air-bearing surface (ABS)” is used herein to refer to the gas-bearing surface of a slider, regardless of whether the gas within the drive is air or another gas (e.g., predominantly helium) or a mixture of gases.) As the air or gas passes under the slider 128 ABS, compression of the air or gas along the air flow path causes the air pressure between the recording media 116 and the slider 128 to increase, which creates a hydrodynamic lifting force that counteracts the tendency of the at least one load beam assembly 120 to push the slider 128 toward the recording media 116. The slider 128 thus flies above the recording media 116 but in close proximity to the surface of the recording media 116. The flexure 130 enables the slider 128 to “pitch” and “roll” on the air (or gas) bearing generated by the recording media 116 as it rotates. Thus, during normal operation, the recording head 129 remains slightly above the surface of the recording media 116, riding on the air bearing.

The data storage device 100 of FIG. 1A also includes a rotary actuator assembly 140 rotationally mounted to the rigid base 112 at a pivot point 141. The rotary actuator assembly 140 may include a voice coil motor (VCM) actuator that includes a magnet assembly 142 fixed to the rigid base 112 and a voice coil 143. The voice coil 143 is a coil of wire attached to the recording head 129 assembly. It is situated within the magnetic field of the magnet assembly 142. The voice coil 143 is mounted on the rotary actuator assembly 140. As the electric current varies in the voice coil 143, the resulting magnetic field interacts with the magnet assembly 142, causing a force that moves the entire rotary actuator assembly 140. The movement of the rotary actuator assembly 140 positions the recording head 129 over the desired data track on the recording media 116.

When energized by control circuitry, which may include, for example, a processor, the voice coil 143 moves and thereby rotates E-block 124 with the rigid arms 122 and the at least one load beam assembly 120 to position the recording head 129 over the data tracks on the recording media 116. As the recording media 116 rotates in the direction of the curved arrow 117 shown in FIG. 1A, the movement of the rotary actuator assembly 140 allows the recording head 129 on the slider 128 to access different data tracks on the recording media 116. The process of moving the recording head 129 to the correct track is known as “seeking.”

The array 32 of electrically conductive interconnect traces or lines connects at one end to the recording head 129 and at its other end to read/write circuitry contained in an electrical module or chip 150, which, in the data storage device 100 of FIG. 1A, is secured to a side of the E-block 124. The chip 150 includes a read/write integrated circuit (R/W IC). The chip 150 may include a controller (e.g., as part of the R/W IC or external to it). The chip 150 may assist in the implementation of the techniques described herein.

To read information from the recording media 116, the recording head 129 may include at least one read head or read sensor. The read sensor(s) in the recording head 129 may include, for example, one or more giant magnetoresistance (GMR) sensors, tunneling magnetoresistance (TMR) sensors, or another type of magnetoresistive sensor. When the slider 128 passes over a track on the recording media 116, the recording head 129 (via the read head) detects changes in resistance due to magnetic field variations recorded on the recording media 116, which represent the recorded bits.

To write information to the recording media 116, the recording head 129 includes a write head (or write portion). In general, the write head can be any suitable write head. Some of the examples included herein describe and illustrate a HAMR head, but it is to be appreciated that the disclosed techniques are applicable to other types of recording head 129.

In operation, after the voice coil 143 has positioned the recording head 129 over the data tracks on the recording media 116, the recording head 129 may be used to write information to one or more tracks on the surface of the recording media 116 and to read previously-recorded information from the tracks on the surface of the recording media 116. The tracks may comprise discrete data islands of magnetizable material (e.g., bit-patterned media), or the recording media 116 may have a conventional continuous magnetic recording layer of magnetizable material. Processing circuitry in the data storage device 100 (e.g., on the chip 150) provides to the recording head 129 signals representing information to be written to the recording media 116 and receives from the recording head 129 signals representing information read from the recording media 116. In operation, and as will be described in detail below, an oxygenation module 170 can be used to control, or maintain, a level of the oxygen contained in the data storage device 100. In one aspect, the oxygenation module 170 is positioned within a sealed enclosure of the data storage device 100.

FIG. 1B is a side schematic view of the head/slider 128 and magnetic recording medium 116 of FIG. 1A, according to one embodiment. The slider 128 may include a sub-mount 160 attached to a top surface of the slider 128. The laser 162 may be attached to the sub-mount 160, and possibly to the slider 128. The slider 128 includes a write element (e.g., writer) 128a and a read element (e.g., reader) 128b positioned along an air bearing surface (ABS) 128c of the head/slider for writing information to, and reading information from, respectively, the medium 116. In other aspects, the slider may also include a layer of the lubricant (not shown).

In operation, the laser 162 is configured to generate and direct light energy to a waveguide (possibly along the dashed line) in the slider which directs the light to a near field transducer (NFT) near the air bearing surface (e.g., bottom surface) 128c of the head/slider 128. Upon receiving the light from the laser 162 via a waveguide, the NFT generates localized heat energy that heats a portion of the medium 116 near the write element 128a and the read element 128b. The anticipated recording temperature is in the range of about 350° C. to 400° C. In the aspect illustrated in FIG. 1B, the laser directed light is disposed between the writer 128a and a trailing edge of the slider. In other aspects, the laser directed light may instead be positioned between the writer 128a and the reader 128b. FIGS. 1A and 1B illustrate a specific aspect of a HAMR system. In other aspects, the oxygenation module 170 of the disclosure can be used in other suitable HAMR systems (e.g., with other HDDs configured for HAMR and in need of oxygen regulation).

As explained above, smear can be a problem for data storage devices 100 (e.g., HAMR devices). As also explained above, oxygen molecules in a sealed data storage device 100 tend to be consumed (e.g., the amount of oxygen decreases) as the data storage device 100 ages, which can make smear more of a problem the longer the data storage device 100 is in operation. The rate of loss of oxygen is generally proportional to temperature.

What is needed are devices and techniques that allow additional oxygen to be introduced into a sealed data storage device 100 as it operates (e.g., to compensate for or replace oxygen lost/consumed as the data storage device 100 operates). Such techniques are described herein utilizing the oxygenation module 170. Although the some of the discussion herein assumes that the gas lost/consumed during operation of the data storage device 100 is oxygen, it is to be appreciated that the disclosure is applicable to other gases or combinations of gases. Thus, generally speaking, the disclosures herein concern the replenishment of gas (either a single gas or a mixture of gases) as a data storage device 100 (e.g., a sealed data storage device 100) operates/ages. In some embodiments, the replenishment is passive and occurs as a result of temperature changes inside of the data storage device 100. In some embodiments, the replenishment is active and occurs as the result of an intervention (e.g., by a processor, such as to cause a temperature increase inside of the data storage device 100). In some embodiments, the disclosed techniques replenish oxygen consumed by oxidation and/or other processes.

FIG. 2 is a plot illustrating general trends of gas consumption by a sealed data storage device 100 as it operates. The x-axis represents time, and the y-axis represents the amount of a gas (e.g., oxygen) in the data storage device 100. The plot in FIG. 2 shows the effects over time of temperature and pressure on gas consumption, in particular to show the effects of higher and lower pressures, and higher and lower temperatures. The solid curve represents the gas-consumption trend when the pressure inside the data storage device 100 is at a higher level, and the operating temperature is at a lower level. As shown, in a higher pressure, lower temperature condition, the amount of gas in the data storage device 100 decreases over time, but the consumption is relatively slow and consistent.

The dashed curve represents the trend when the pressure inside the data storage device 100 is at the higher level (same as for the solid curve), but the temperature is higher than for the solid curve. As shown, the effect of the higher temperature is that gas is consumed more rapidly than when the temperature is lower. Thus, FIG. 2 indicates that gas is consumed at a higher rate when the temperature is higher, even when the pressure remains constant.

The dash-dot curve in FIG. 2 shows the effect of lower pressure. The dash-dot curve represents the trend when the pressure inside the data storage device 100 is lower than for the solid or dashed curves, and the temperature is higher (same as for the dashed curve). Under these conditions, the rate of gas consumption is even higher. A comparison between the dashed and the dash-dot curves shows that the effect of the lower pressure is that more gas is consumed per unit time. In a sense, the dash-dot curve represents a worst-case scenario of lower pressure and higher temperature.

The data storage device 100 can be improved by compensating for the consumption of gas (a single gas or mixture of gases) as the data storage device 100 operates, and that such compensation can be accomplished either passively or actively. For example, passive compensation can be accomplished by including in the data storage device 100 a gas-releasing substance that releases gas to replace gas being consumed as the data storage device 100 operates, where the quantity is selected to provide the amount of gas expected to be consumed by the data storage device 100 over its lifetime, during its warranty period, or over any predetermined time period. For example, the gas-releasing substance can release a quantity of gas the data storage device 100 is expected to consume over a particular number of years (e.g., 3 years, 4, years, 5 years, 6 years, etc.). As a specific example, the gas-releasing substance can release a quantity of gas the data storage device 100 is expected to consume over at least 1 years. Because the consumption of gas within the data storage device 100 is temperature-dependent and pressure-dependent, the identity of the gas-releasing substance (which material(s)) and the amount of the gas-releasing substance can be selected during the design process so that as the data storage device 100 operates, and molecules of the gas originally present are consumed (e.g., for oxidation of smear, etc.), the consumed molecules are replaced by molecules of gas released by the gas-releasing substance. The identity and quantity of the gas-releasing substance can be selected so that the release of gas under the expected temperature and pressure conditions substantially matches the consumption of gas. In other words, the gas-release profile of the gas-releasing substance can be matched to the expected operating conditions so that the total amount of the gas inside of the data storage device 100 remains substantially consistent, because consumed gas is being replenished at substantially the rate of consumption.

As a specific example, a temperature-sensitive gas-releasing substance can be situated within a core area of the voice coil 143 winding. When current flows through the voice coil 143 winding, the core area is heated due to resistive heating (i.e., the current encounters resistance as it passes through the metal voice coil 143 winding, which causes the metal to heat up and heat the area around it). Current flow through the voice coil 143 winding occurs as a matter of course as the data storage device 100 operates (e.g., when it is seeking). Thus, the heat naturally generated by the voice coil 143 during the ordinary operation of the data storage device 100 (e.g., during seeking operations) may be able to heat the gas-releasing substance to above a critical temperature and cause it to release gas to replenish gas consumed by the data storage device 100 (e.g., via oxidation and other processes). For example, the gas-releasing substance may release gas at a rate that is substantially similar to the rate at which the data storage device 100 consumes the gas over the expected operating temperature range. In this way, gas consumed by the data storage device 100 can be replenished passively, substantially in real time, as the data storage device 100 operates and consumes the gas.

Active compensation can be accomplished by including hardware and/or software in the data storage device 100 that can cause the gas-releasing substance to release gas (or to release more gas than it ordinarily would) at a selected time and/or under specified conditions. For example, the gas-releasing substance can be situated in a core area of the voice coil 143 winding of a data storage device 100. A controller in the data storage device 100 can cause current (or additional current) to flow through the voice coil 143 winding when the data storage device 100 is in a state in which the current can be increased for the purpose of heating the core area in order to heat the gas-releasing substance and cause it to release gas. If present, the controller can be coupled to a temperature sensor (e.g., a thermocouple) that can detect the temperature of (or in the vicinity of) the gas-releasing substance. Alternatively or in addition, the controller can be coupled to a sensor that detects the gas level (or a proxy for the gas level). The controller can then determine how much current to apply to the voice coil 143 winding, and for how long, to cause the gas-releasing substance to release a specified amount of gas, or to release gas at a particular rate (e.g., determined by the gas-release profile).

Oxygen (O₂) is a gas that is consumed by the data storage device 100 when the data storage device 100 is heated above room temperature, such as a temperature of about 40° C. or higher. Crystalline salts of cationic multimetallic transition metal complexes are oxygen releasing substances that can be utilized in the data storage device 100 to generate oxygen in order to replace the oxygen that has been consumed. For example, the crystalline salts of cationic multimetallic transition metal complexes, which may be referred to herein as an oxygenating material, may release oxygen when the data storage device 100 is heated above a temperature of about 50° C. The crystalline salts may be utilized alone or mixed with an organic material, an inorganic material, or a desiccant, such as silica gel, molecular sieves, calcium peroxide, or magnesium peroxide, for example. The crystalline salts of cationic multimetallic transition metal complexes may be disposed in the oxygenation module 170. Such oxygen releasing crystalline salts comprise a cation and a counteranion.

The counteranion is selected from the group consisting of: perchlorate (ClO₄—), tetrafluoroborate (BF₄—), hexafluorophosphate (PF₆—), trifluoromethanesulfonate (CF₃SO₃—), sulfate, halides, chloride, bromide, fluoride, iodide, astatine, nitrate, thiocyanate, acetate, carbonate, selenite, oxalate, phosphate, thiosulfate, silicate, metasilicate, chromate, dichromate, permanganate, citrate, cyanide, nitrite, chlorate, antimonite hexachloro-antimonate, hexafluoro antimonate, arsenate, arsenite, molybdenum, hexafluorosilicate, and aluminate.

The cation comprises a cationic transition metal complex. Transition metal ions chelating with N and O⁻ that can react reversibly with oxygen to form peroxide O₂²⁻ and release O₂ at elevated temperature can be used as the cation. N coordination can be from organic amines and pyridinyl nitrogen, and O⁻ coordination can be from phenolate or carboxylate, with a metal selected from Co, Ni, Mn, Fe, or Cu.

The cation may be one of structures 1 or 2: structure 1: ([(2-pyridylmethyl)aminomethyl)-4-tert-butylphenolato)M₂(O₂)(R1)ₘ]^{2m+}); or structure 2: [M₂(bpcd)₂(H₂O)₂]²⁺

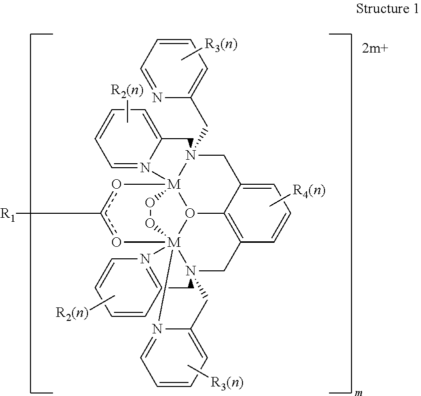

In structure 1, m is a numeral greater than or equal to one, where the 2m+ charge is the numeral m multiplied by 2. The numeral m indicates how many repeating units of structure 1 are included in the crystalline salt, and m is a number between 1 and 100 or more. The numeral n is a number between 0 and 4. The transition metal M is selected from the group consisting of: Co, Ni, Mn, Fe, and Cu.

R1-COOH may contain multiple carboxylate functional groups to connect with multiple cationic multimetallic complexes, such as dicarboxyl or tricarboxyl benzene. R1-COOH is selected from a group (1) through (13) consisting of: (1) methyl, (2) phenyl, (3) choloromethyl, (4) dicholoromethyl, (5) tricholoromethyl, (6) ethylsulfide, (7) a polymer comprising carboxyl repeating units, (8) 1,4-dicarboxyl benzene, (9) 1,3-dicarboxyl benzene, (10) 1,2-dicarboxyl benzene, (11) 1,3,5-tricarboxyl benzene, (12) naphthalene comprising 3 carboxyl groups, and (13) anthracene comprising 3 carboxyl groups, and where 1,4-dicarboxyl benzene, 1,3-dicarboxyl benzene, 1,2-dicarboxyl benzene, 1,3,5-tricarboxyl benzene, naphthalene, and anthracene (i.e., groups (8)-(13)) can be substituted or non-substituted. R1 can be tuned by the substitutions on the basic framework using electron donating or withdrawing groups. The electron donating group or withdrawing group can be F, Cl, Br, I, carbonyl, carboxyl, hydroxyl, alkyl, aryl, amine, amide, nitro, and so on.

For example, when m is one, R1-COOH is selected from the group consisting of: 1a) methyl, 1b) phenyl, 1c) chloromethyl, 1d) dichloromethyl, 1e) trichloromethyl, and 1f) ethylsulfide. R2, R3, and R4 can be selected from the group consisting of: F, Cl, Br, I, CH₃, ethyl, propyl, n-butyl, tert butyl, carbonyl, carboxyl, hydroxyl, alkyl, aryl, amine, amide, and nitro.

When m is 1, R1-COOH is one of:

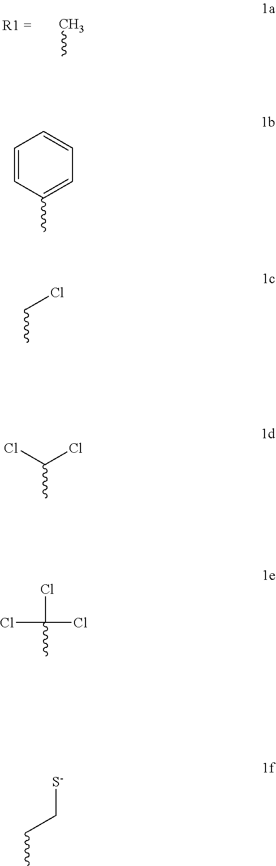

An example of structure 1 where m is one is shown below as structure 1-1.

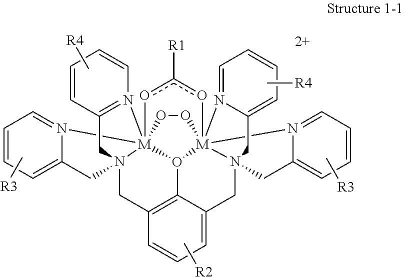

When m is two, R1-COOH has two carboxyl groups and can be selected from non-substituted or substituted 1,4-dicarboxyl benzene for example. The substitution can be NH₂, F, Cl, or a combination thereof. Non-substituted and substituted 1,3, and 1,2-dicarboxyl benzene can also be selected. Other fused rings such as naphthalene anthracene can replace benzene ring in this case as it would be recognized by people skilled in the artisan.

For example, when m is 2, R1 may be:

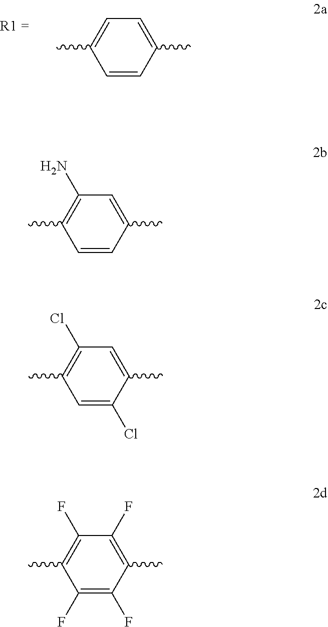

An example of structure 1 where m is two is shown below as structure 1-2.

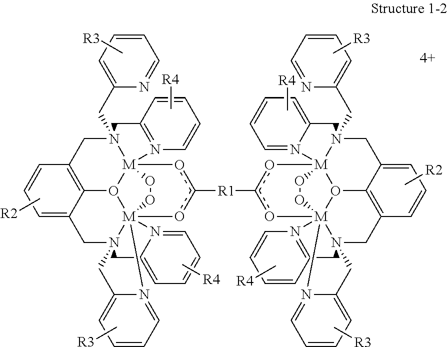

When m is three, R1-COOH can be selected from non-substituted and substituted 1,3,5-tricarboxyl benzene. Substitution(s) can tune the oxygen releasing property and be selected from F, Cl, Br, NH₂, alkyl, and a combination thereof. Other fused rings such as naphthalene comprising 3 carboxyl groups and anthracene comprising 3 carboxyl groups can replace benzene ring in this case as it would be recognized by people skilled in the art, like discussed above.

For example, when m is 3, R1 may be:

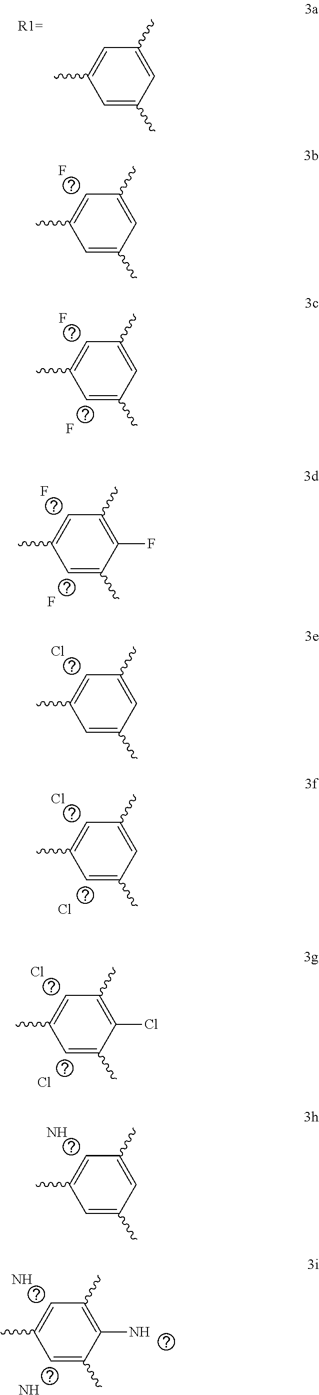

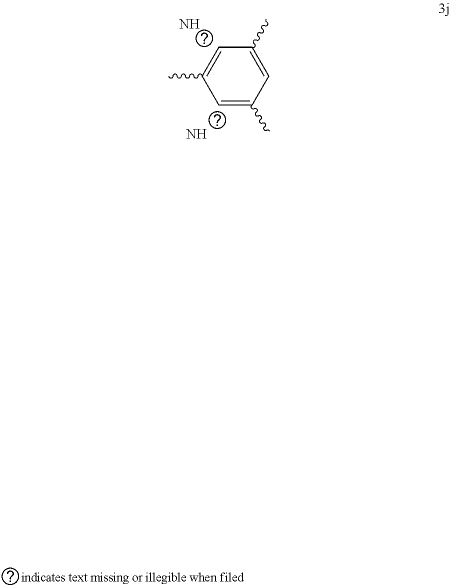

When m is four or greater, R1-COOH has 4 or more carboxyl groups and can be selected from a fused ring system such as naphthalene and anthracene or a polymer with carboxyl repeating units.

For example, when m is equal to or greater than 4, R1 may be:

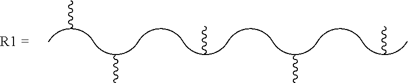

In theory, a transition metal selected from the group of Co, Ni, Mn, Fe, and Cu with nitrogen and oxygen chelation can have oxygen releasing property. Structure 2 below is believed to exhibit similar properties as the structures discussed previously.

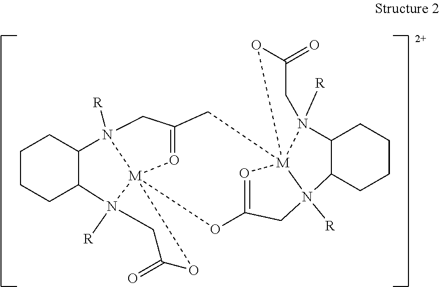

The crystalline salts of cationic multimetallic transition metal complexes can be used with other organic and inorganic O₂ releasers. For example, the crystalline salts of cationic multimetallic transition metal complexes may further be used together with inorganic oxygen releases, such as permanganates, peroxides, percarbonates, and combinations thereof, such as AgMnO₄, KMnO₄, H₂O₂, CaO₂, MgO₂, KClO₃, NaBO₃, H₂O, K₂S₂O₈, or Na₂CO₃·1.5H₂O₂. The oxygen releasing system may comprise at least one organic oxygen releaser such as transitional metal complex salt and transitional metal salen or transitional metal acacen or Metal-organic frameworks (MOFs) to control an oxygen releasing profile in the magnetic storage device, as discussed further below. The crystalline salts of cationic multimetallic transition metal complexes may be mixed together with desiccants such as silica gel, molecular sieves or calcium peroxide, magnesium peroxide, and so on.

As described further below, the crystalline salts may be heated by the drive temperature or by an in-situ heater or cooled by in-situ cooler in order to regulate the amount of oxygen as needed. In one embodiment, the crystalline salts are disposed in a cell or sealed chamber within the data storage device 100, where the opening of the sealed chamber is controlled by an oxygen sensor that only opens the opening when the level of oxygen within the drive is low. The opening of the cell may be covered by an oxygen permeable membrane or the cell itself may be made of oxygen permeable membranes. In another embodiment, the crystalline salt is packaged in an oxygen permeable membrane that has a thickness, surface area, and membrane material tailored to match the oxygen depleting speed of the data storage device 100. The oxygen permeable membrane may comprise at least one of polytetrafluoroethylene (PTFE), low density polyethylene, high density polyethylene, ethylene vinyl acetate, polyurethane, polyvinyl alcohol, or isoprene rubber. The cell can be either gas permeable or gas-impermeable and may comprise at least one of aluminum, steel, nickel, zinc or plastic.

Oxygen is constantly released when the drive is heated such that a level of oxygen within in the data storage device 100 is maintained at about 8% to about 12% of a total atmosphere of the data storage device 100. When the data storage device 100 is not heated or at room temperature (RT) (e.g., at a temperature below about 30° C.), crystalline salt comprising structure 1 are able to absorb any excess oxygen for storage. Thus, the releasing of the oxygen is reversible. Equation 1 below illustrates an example of structure 1-2 comprising Co being heated and releasing oxygen.

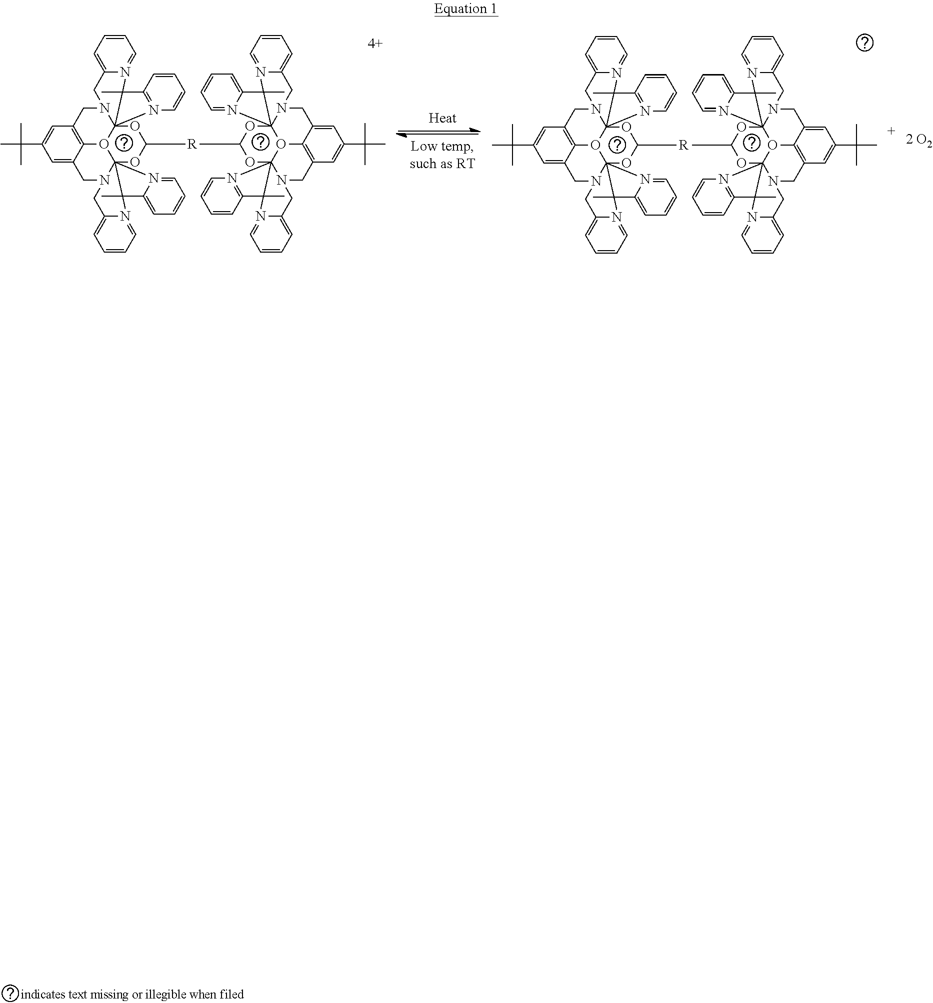

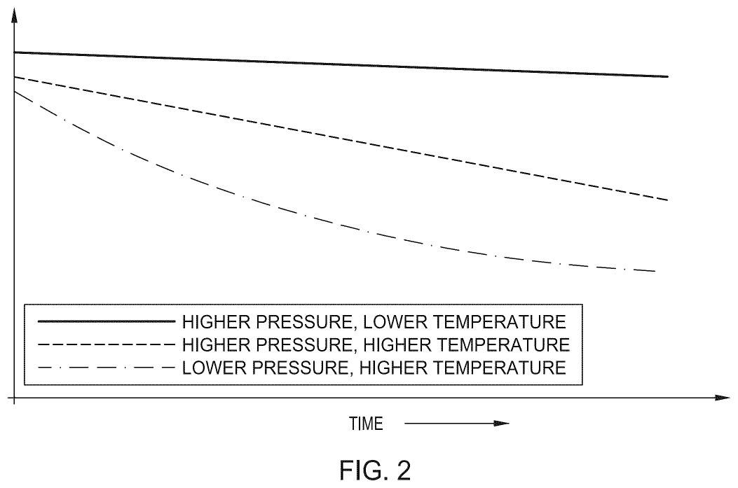

FIG. 3 illustrates a graph 300 illustrating the release of oxygen over time when the data storage device 100 is heated and cooled, according to one embodiment. The graph 300 is based on a crystalline salt comprising a counteranion of BF₄— and structure 1-2, where structure 1-2 comprises Co, an R1 group of 2a, and an R2 group of CH₃. Line 302 represents oxygen being released and line 304 represents the temperature. As shown by the graph 300, as the temperature increases, the percent weight of cationic complex salt decreases, representing O₂ being released. When the temperature decreases, the percent weight of O₂ increases, representing cationic complex salt being absorbed and stored.

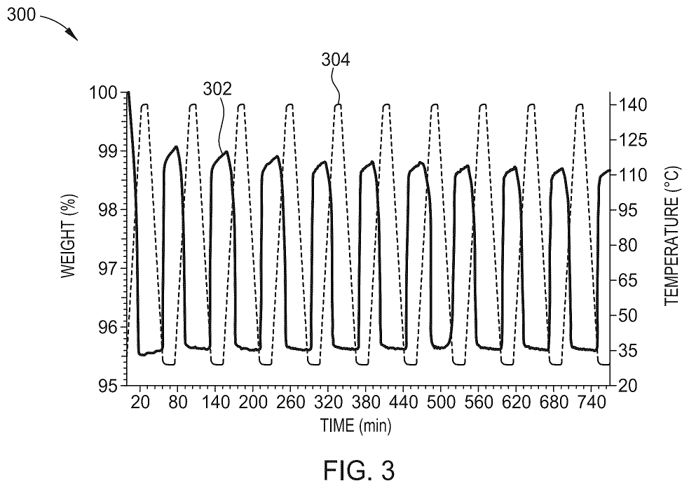

The counteranion in the metal complexes comprising one of structures 1 or 2 determines the O₂ releasing speed and releasing temperature. FIG. 4 illustrates a graph 400 showing the effect the counteranions have on oxygen releasing temperature, according to one embodiment. The graph 400 is based on structure 1-2 comprising Co, an R1 group of 2a, and an R2 group of CH₃. As shown in the graph 400, when NO₃— is utilized with structure 1, the NO₃ comprising crystalline salt oxygen releasing peak is at around 75° C. A crystalline salt comprising BF₄— has an oxygen releasing peak at around 90° C., a PF₆— comprising crystalline salt has an oxygen releasing peak around 110° C., and a CF₃SO₃-comprising crystalline salt has an oxygen releasing peak around 125° C. However, the NO₃— comprising crystalline salt and the CF₃SO₃— comprising crystalline salt releasing oxygen at a significantly lower rate than the PF₆— comprising crystalline salt and the crystalline salt comprising BF₄— (i.e., hours versus sub-seconds). PF₆— or BF₄— have a fast chemsorb speed and a slow releasing speed at standard operating temperatures of the data storage device. Such properties provide the opportunity of mixing transition metal crystalline salts with different counterions, and having the desired oxygen releasing profiles in the storage device.

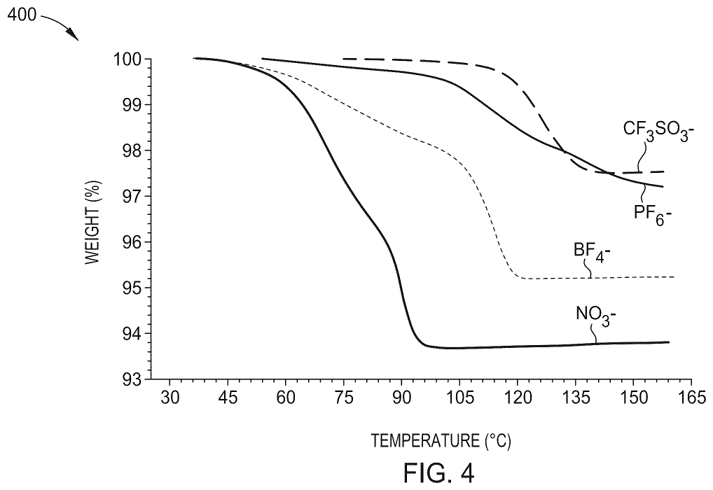

The R1-GOGH selected for structure 1 also determines the O₂ releasing speed and releasing temperature. FIG. 5 illustrates a graph 500 showing the effect of the R1 substitution has on oxygen releasing temperature, according to one embodiment. The graph 500 is based on a counteranion of NO₃ and the structure 1-2 comprising Co and an R2 group of CH₃. As shown in the graph 500, when structure 1-2 comprises the R1 group 2a, the oxygen releasing peak temperature is about 75° C., when structure 1-2 comprises the R1 group 2b, the oxygen releasing peak temperature is about 90° C., when structure 1-2 comprises the R1 group 2c, the oxygen releasing peak temperature is about 80° C., and when structure 1-2 comprises the R1 group 2d, the oxygen releasing peak temperature is about 90° C. The R1 groups having a lower oxygen releasing temperature have a faster oxygen releasing speed.

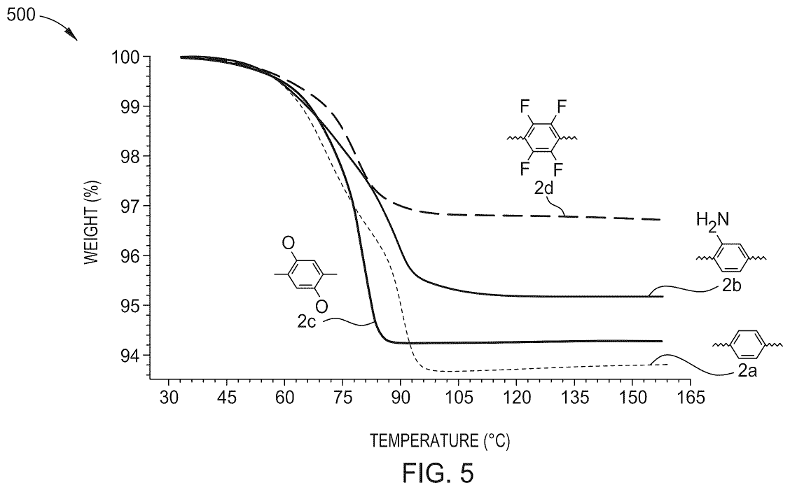

FIG. 6 is a schematic diagram of the oxygenation module/cell 610, which corresponds to the oxygenation/module cell 170 depicted in the perspective view of the HDD of FIG. 1A. The oxygenation module 610 includes an outer case or cell 612, the top of which has an opening covered by an O₂ permeable membrane 614. Inside the case or cell 612 is the oxygenated transitional metal complex salts 616 of the disclosure, which may be in the form of a powder, a pellet, a solid or is disposed on a woven material. The oxygenated transitional metal complex salts can also be disposed on a zeolite, a nanotube or other nanomaterial. The nanotube or nanomaterial can be carbon based. An inorganic material such as permanganates, peroxides, percarbonates or the like may be mixed with the transitional metal complex salts. The cell 610 may be made from a metal (e.g., a gas permeable or gas impermeable metal enclosure) such as steel, aluminum, zinc or nickel. The metal can be made gas permeable by sintering. Alternately, the cell may be formed from a gas permeable or gas impermeable plastic such as an acrylate, a methacrylate or a polyurethane. The oxygen releaser can be packed in a gas permeable membrane pouch as well, where both of the cells and the permeable membrane are made from the same materials, such as PTFE membrane. Optionally, there could be a heating element 618 inside the outer casing of the HDD or attached to the outer casing of the HDD. However, the heating element may not be required, since heat will be supplied by the operation of the drive itself. The oxygenation module can contain a sufficient amount of the transitional metal complex salts to last for the lifetime of the drive and still be relatively small in size. For example, it can be the size of a button cell battery with a diameter of from 0.5 cm to 5 cm. The oxygenation module can also include an oxygen sensor and a controller (not shown). In the example illustrated in FIG. 6 and described above, the oxygenation module or cell 610 is referred to as being passive. In other aspects, it may be passive or active. The oxygenation module can be a 0.5 cm to 5 cm gas permeable membrane pouch with oxygen releaser inside.

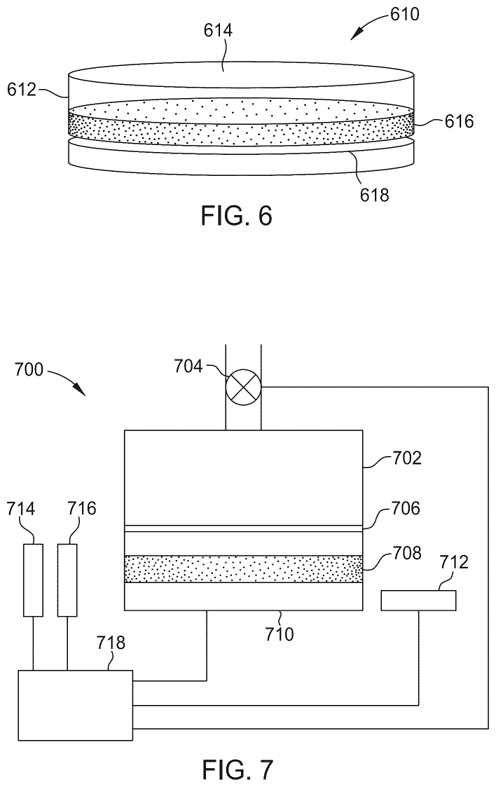

FIG. 7 is a schematic diagram of an oxygenation module 700 according to an embodiment of the disclosure. The oxygenating module 700 may be the oxygenating module 170 of FIG. 1A. The oxygenation module 700 includes a case or cell 402, the top of which has an outlet tube equipped with a valve 704. An O₂ permeable membrane 406 assures that none of the transitional metal complex salts material 708 escapes from the module. A heating element 710 is inside the casing 702 or attached to the casing 702. An alternate way to heat the transitional metal complex salts material would be by using a laser 712. Oxygen sensor 714 and temperature sensor 716 monitor the environment inside the HDD. The oxygen sensor 714 and temperature sensor 716 feed sensor data to the controller 718, which then operates the heater, laser and valve to modulate the amount of oxygen that is effused into the He atmosphere of the HDD. In one aspect, either the heater 710 or the laser 712, whichever is present in the oxygenation module 700, may act as a temperature control device to control the amount of heat, or lack of heat (e.g., cooling), applied to the transitional metal complex salts material 708.

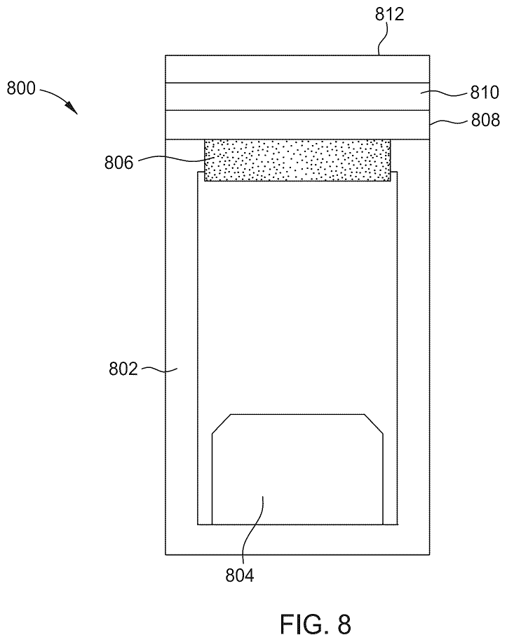

FIG. 8 is a schematic diagram of another design of an oxygenation module according to aspects of the disclosure. The oxygenating module 800 may be the oxygenating module 170 of FIG. 1A. The oxygenation module 800 includes a case or cell 802 that contains the transitional metal complex salts based material 804. The top of the case 802 is sealed by an oxygen permeable membrane 806 which accesses a chamber 808 which defines a volume of oxygenated gas to be released. The chamber 808 leads to a porous cap 810 which can be a fritted grid or a porous material such as sintered stainless steel. The module can function passively or the oxygenated gas can be released by an optional valve 812.

The oxygen permeable membrane can be formed from a polymer such as PTFE, cellophane, polythene, polytetrafluoroethylene, high-density polyethylene (HDPE) having a density of 0.93-0.97 g/cm³, and low-density polyethylene (LDPE) having a density of 0.92-0.93 g/cm³, polyvinyl acetate (PVA), ethylene vinyl acetate (EVA), polyurethane (PU), rubber, elastomer, etc. The oxygen permeable membrane can also be formed from an inorganic material or ceramic such as silica, zeolite, metal organic frameworks or perovskite. Perovskite-type and fluorite oxides are promising materials with high-oxygen ionic conductivity for oxygen permeation. Perovskite oxides are usually denoted as ABO₃-δ, where A-site ions usually are alkaline earth metal ions (Ba²⁺, Sr²⁺, Ca²⁺) and/or lanthanide metal ions (La³⁺, Sm³⁺, Ga³⁺, etc.). Fluorite oxides are often denoted as MO₂-δ, and the typical fluorite oxides are ZrO₂, CeO₂, Bi₂O₃ and their alkaline earth or rare earth doped oxides. Mixed ionic/electronic conduction is required for oxygen transport through membranes. Typical membrane composition may include Ln₁₋ₓ(Ba,Sr,Ca)ₓCo_{1-y}Fe_{y}O_{3-dδ} (Ln: lanthanide) or Ba₁₋ₓSrₓCo_{0.8}Fe_{0.2}O_{3-δ} and La₁₋ₓSrₓCo_{1-y}Fe_{y}O_{3-δ}.

If the transitional metal complex salts is present in particulate form, the particle size can be adjusted to modulate the release of oxygen, since decreasing particle size increases the overall surface area, i.e., increasing the particle size decreases the rate of oxygen evolution. Maximum oxygen evolution is expected at a mean particle size of 1-5 nm. If a lower oxygen evolution is desired, the particle size can be increased to micron or millimeter levels.

The transitional metal complex salts can be coated on or inculcated into nanotubes. Carbon nanotubes can be single-walled carbon nanotubes (SWCNTs) which have diameters around 0.5-2.0 nm, about 100,000 times smaller than the width of a human hair. They can be idealized as cutouts from a two-dimensional graphene sheet rolled up to form a hollow cylinder. Multi-walled carbon nanotubes (MWCNTs) are formed of single-wall carbon nanotubes in a nested, tube-in-tube structure. Double-walled and triple-walled carbon nanotubes are special cases of MWCNT. Another carbonaceous nanomaterial is Buckminsterfullerene, a type of fullerene with the formula C₆₀. It has a cage-like fused-ring structure (truncated icosahedron) made of twenty hexagons and twelve pentagons, and resembles a football. Each of its 60 carbon atoms is bonded to its three neighbors.

The transitional metal complex salts compound can be coated on or inculcated into zeolites, which are microporous, crystalline aluminosilicate materials commonly used as commercial adsorbents and catalysts. They mainly are formed of silicon, aluminum, and oxygen, and have the general formula Mⁿ⁺_{1/n}(AlO₂)—(SiO₂)ₓ·yH₂O where Mⁿ⁺_{1/n} is either a metal ion such as Na or H+. Zeolites have microporous structures with a typical diameter of about 0.3-0.8 nm. Like most aluminosilicates, the framework is formed by linking of aluminum and silicon atoms by oxides. This linking leads to a 3-dimensional network of Si—O—Al, Si—O—Si, and AI-O-AI linkages. The aluminum centers are negatively charged, which requires an accompanying cation. Zeolites can form naturally in nature. Some of the more common mineral zeolites are analcime, chabazite, clinoptilolite, heulandite, natrolite, phillipsite, and stilbite. An example of the mineral formula of a zeolite is: Na₂Al₂Si₃O₁₀·2H₂O, the formula for natrolite.

The transitional metal complex salts material can be in the form of a tablet. Tablets are prepared either by molding or by compression of the transitional metal complex salts material. Additives can include diluents, binders or granulating agents, glidants (flow aids) and lubricants to ensure efficient tableting. A polymer coating can be applied to make the tablet smoother and to control the release rate of oxygen. A binder may be added to help hold the tablet together and give it mechanical strength. A wide variety of binders may be used: some common ones are lactose, dibasic calcium phosphate, starch, microcrystalline cellulose, povidone polyvinylpyrrolidone and modified cellulose (for example, hydroxypropyl cellulose and hydroxyethyl cellulose, known as KLUCEL, which can have molecular weights ranging from 40,000 to 1,150,000).

In an embodiment, the transitional metal complex salts material can be incorporated into a paint coating for the wall of the HDD casing. The paint can be acrylic, varnish or oil based paint. The active material can be dissolved into the paint, or dissolved in a solvent (which can be the activating solvent) that is then added to the paint. The coating can then be sprayed on, brushed on or printed on the wall of the HDD casing. A paint that does not contain pigment can be used. The active material can be encapsulated before being added to the paint, so as to modulate the absorption or release of oxygen. The encapsulating material can be a polymer such as polyvinylpyrrolidone, polyethylene glycol, acrylates, methacrylates, polymeric melamine-formaldehyde, etc. The paint can also be coated on the inside of the cell.

Modulating the release of oxygen can also be achieved by mixing the transitional metal complex salts with inorganic materials. Single or mixtures of activated transitional meal complex salts provide the required oxygen releasing profile in HDD. The single or mixture of activated transitional metal complex salts mixes with other inorganic oxygen releasers. Transitional metal complex salts as oxygen modulators utilize its reversible oxygen adsorption/desorption property. At the start, the transitional metal complex salts may have no oxygen, but they absorb oxygen generated by the inorganic releasing agent and release oxygen slowly at elevated temperatures. One advantage is to prevent an oxygen surge by rapid oxygen release from inorganic compounds early in the lifetime of the HDD. The inorganic materials can include permanganates, for example AgMnO₄ (silver permanganate), and KMnO₄ (potassium permanganate), or percarbonates such as Na₂H₃CO₆ (sodium percarbonate) and K₂H₃CO₆ (potassium percarbonate), or peroxides such as CaO₂ and MgO₂.

In an embodiment, the starting transitional metal complex salts are partially or fully loaded with oxygen. They reach an equilibrium of releasing oxygen into the HDD and absorbing oxygen generated by inorganic compounds to keep HDD oxygen level constant at the optimum level. Oxygen release can be attained by the HDDs running temperature. The heating element can also be used to release oxygen. Optionally, a laser can create a local high temperature for quick oxygen release. The transition metal complexes can be disposed in a sealed chamber.

Therefore, by utilizing a crystalline salt comprising one of structures 1 or 2 and a counteranion, the amount of oxygen within a data storage device can be regulated as needed. Such crystalline salts can both absorb and desorb oxygen to maintain a constant level of oxygen within the data storage device. By regulating the amount of oxygen within the data storage device, the data storage device has a higher reliability and lifetime.

In one embodiment, a data storage device comprises a crystalline cationic multimetallic transition metal complex salt configured to release oxygen, the crystalline cationic multimetallic transition metal complex salt comprising: a counteranion selected from the group consisting of: perchlorate (ClO₄—), tetrafluoroborate (BF₄—), hexafluorophosphate (PF₆—), trifluoromethanesulfonate (CF₃SO₃—), sulfate, halidse, chloride, bromide, fluoride, iodide, astatine, nitrate, thiocyanate, acetate, carbonate, selenite, oxalate, phosphate, thiosulfate, silicate, metasilicate, chromate, dichromate, permanganate, citrate, cyanide, nitrite, chlorate, antimonite hexachloro-antimonate, hexafluoro antimonate, arsenate, arsenite, molybdenum, hexafluorosilicate, and aluminate; and structure 1:

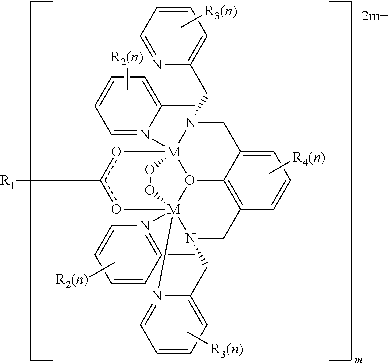

wherein M is selected from the group consisting of: Co, Ni, Mn, Fe, and Cu, wherein n is a numeral between 0 and 4, and wherein m is a numeral between 1 and 100, m being the number of repeating units of structure 1.

One or more of R2, R3, and R4 is selected from the group consisting of: F, Cl, Br, I, CH₃, ethyl, propyl, n-butyl, tert butyl, carbonyl, carboxyl, hydroxyl, alkyl, aryl, amine, amide, and nitro. The crystalline salt is in the form of a powder or tablets, or wherein the oxygenating material is coated on zeolites or nanotubes. The crystalline salt is configured to release oxygen at a temperature greater than about 50° C. The crystalline salt is configured to store oxygen at a temperature below about 30° C. In structure 1, m is one, and R1-COOH is selected from the group consisting of: methyl, phenyl, choloromethyl, dicholoromethyl, tricholoromethyl, and ethylsulfide. The counteranion and R1 are selected to determine an oxygen releasing speed and an oxygen releasing temperature. In structure 1, m is two, and R1-COOH is selected from the group consisting of: non-substituted and substituted 1,4-dicarboxyl benzene, 1,3-dicarboxyl benzene, or 1,2-dicarboxyl benzene, wherein when substituted, the substitution is selected from the group consisting of: F, Cl, NH₂, alkyl, carbonyl, and a combination thereof. In structure 1, m is three, and R1-COOH is selected from the group consisting of: non-substituted and substituted 1,3,5-tricarboxyl benzene, naphthalene comprising 3 carboxyl groups, and anthracene comprising 3 carboxyl groups, wherein when substituted, the substitution is selected from the group consisting of: F, Cl, NH₂, alkyl, carbonyl, and a combination thereof. In structure 1, m is greater than or equal to 4, and wherein R1-COOH is a polymer comprising carboxyl repeating units. The crystalline salt further comprises at least one inorganic material selected from the group consisting of: permanganates, peroxides, percarbonates, and combinations thereof.

An oxygenating system comprises the crystalline salt. The crystalline salt is inside a cell inside a sealed casing of the magnetic storage device; an oxygen permeable membrane covers an opening in the cell, the cell being gas impermeable; the cell and the cover are made from a gas permeable membrane; the oxygen permeable membrane comprises at least one of PTFE, low density polyethylene, high density polyethylene, ethylene vinyl acetate, polyurethane, polyvinyl alcohol, or isoprene rubber; and the cell is gas-impermeable and comprises at least one of aluminum, steel, nickel, zinc or plastic.

In another embodiment, an oxygenating material for treating an atmosphere of a magnetic storage device, the oxygenating material comprises a counteranion selected from the group consisting of: perchlorate (ClO₄—), tetrafluoroborate (BF₄—), hexafluorophosphate (PF₆—), trifluoromethanesulfonate (CF₃SO₃—), sulfate, halides, chloride, bromide, fluoride, iodide, astatine, nitrate, thiocyanate, acetate, carbonate, selenite, oxalate, phosphate, thiosulfate, silicate, metasilicate, chromate, dichromate, permanganate, citrate, cyanide, nitrite, chlorate, antimonite hexachloro-antimonate, hexafluoro antimonate, arsenate, arsenite, molybdenum, hexafluorosilicate, and aluminate; and structure 1:

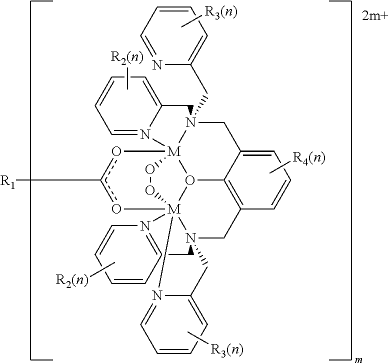

wherein M is selected from the group consisting of: Co, Ni, Mn, Fe, and Cu, wherein n is a numeral between 0 and 4, wherein m is a numeral between 1 and 100, m being the number of repeating units of structure 1, wherein R1-COOH is selected from the group consisting of: methyl, phenyl, choloromethyl, dicholoromethyl, tricholoromethyl, ethylsulfide, a polymer comprising carboxyl repeating units, 1,4-dicarboxyl benzene, 1,3-dicarboxyl benzene, 1,2-dicarboxyl benzene, 1,3,5-tricarboxyl benzene, naphthalene comprising 3 carboxyl groups, and anthracene comprising 3 carboxyl groups, and wherein 1,4-dicarboxyl benzene, 1,3-dicarboxyl benzene, 1,2-dicarboxyl benzene, 1,3,5-tricarboxyl benzene, naphthalene, and anthracene can be substituted or non-substituted.

One or more of R2, R3, and R4 is selected from the group consisting of: F, Cl, Br, I, CH₃, ethyl, propyl, n-butyl, tert butyl, carbonyl, carboxyl, hydroxyl, alkyl, aryl, amine, amide, and nitro. In structure 1, M is Co, and wherein the counteranion and R1-COOH are selected to determine an oxygen releasing speed and an oxygen releasing temperature. The oxygenating material is configured to release oxygen at a temperature greater than about 50° C., and wherein the oxygenating material is configured to store oxygen at a temperature below about 30° C. In structure 1, m is one, and R1-COOH is selected from the group consisting of: methyl, phenyl, choloromethyl, dicholoromethyl, tricholoromethyl, and ethylsulfide. The oxygenating material releases oxygen at a speed that maintains a level of oxygen between about 8% to about 12% of an atmosphere of the data storage device. In structure 1, m is two, and R1-COOH is selected from the group consisting of: non-substituted and substituted 1,4-dicarboxyl benzene, 1,3-dicarboxyl benzene, or 1,2-dicarboxyl benzene, wherein when substituted, the substitution is FF, Cl, Br, I, carbonyl, carboxyl, hydroxyl, alkyl, aryl, amine, amide, nitro, or a combination thereof. In structure 1, m is three, and R1-COOH is selected from the group consisting of: non-substituted and substituted 1,3,5-tricarboxyl benzene, naphthalene comprising 3 carboxyl groups, and anthracene comprising 3 carboxyl groups, wherein when substituted, the substitution is selected from the group consisting of: F, Cl, Br, I, carbonyl, carboxyl, hydroxyl, alkyl, aryl, amine, amide, nitro, and a combination thereof. In structure 1, m is greater than or equal to 4, and wherein R1-COOH is a polymer comprising a carboxyl repeating unit. The crystalline salt constantly releases oxygen when heated to above about 50° C.

The oxygenating material comprises at least one organic oxygen releaser to control an oxygen releasing profile in the magnetic storage device. The oxygenating material is mixed together with one or more desiccants. An oxygenating system comprises the oxygenating material. The oxygenating material is inside a cell inside a sealed casing of the magnetic storage device; and an oxygen permeable membrane covers an opening in the cell. The oxygen permeable membrane comprises at least one of PTFE, low density polyethylene, high density polyethylene, ethylene vinyl acetate, polyurethane, polyvinyl alcohol, or isoprene rubber, and wherein the cell is gas-impermeable and comprises at least one of aluminum, steel, nickel, zinc or plastic. The oxygenating material is in the form of a powder or tablets. The oxygenating material is coated on zeolites or nanotubes.

While the foregoing is directed to embodiments of the present disclosure, other and further embodiments of the disclosure may be devised without departing from the basic scope thereof, and the scope thereof is determined by the claims that follow.

1. A data storage device, comprising:
a crystalline cationic multimetallic transition metal complex salt configured to release oxygen, the crystalline cationic multimetallic transition metal complex salt comprising:
a counteranion selected from the group consisting of: perchlorate (ClO₄—), tetrafluoroborate (BF₄—), hexafluorophosphate (PF₆—), trifluoromethanesulfonate (CF₃SO₃—), sulfate, halides, chloride, bromide, fluoride, iodide, astatine, nitrate, thiocyanate, acetate, carbonate, selenite, oxalate, phosphate, thiosulfate, silicate, metasilicate, chromate, dichromate, permanganate, citrate, cyanide, nitrite, chlorate, antimonite hexachloro-antimonate, hexafluoro antimonate, arsenate, arsenite, molybdenum, hexafluorosilicate, and aluminate; and 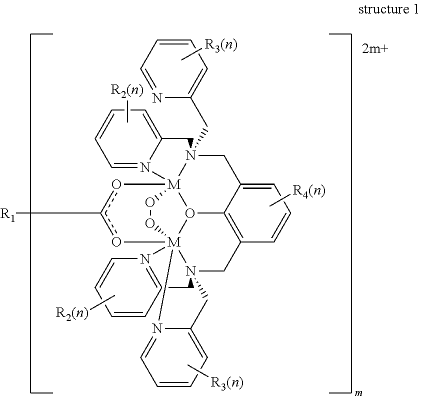
wherein M is selected from the group consisting of: Go, Ni, Mn, Fe, and Cu,
wherein n is an integer between 0 and 4, and
wherein m is an integer between 1 and 100, m being the number of repeating units of structure 1.

2. The data storage device of claim 1, wherein one or more of R2, R3, and R4 is selected from the group consisting of: F, Cl, Br, I, CH₃, ethyl, propyl, n-butyl, tert butyl, carbonyl, carboxyl, hydroxyl, alkyl, aryl, amine, amide, and nitro.

3. The data storage device of claim 1, wherein the crystalline cationic multimetallic transition metal complex salt is in the form of a powder or tablets.

4. The data storage device of claim 1, wherein R1-COOH is selected from the group consisting of: methyl, phenyl, choloromethyl, dicholoromethyl, tricholoromethyl, ethylsulfide, a polymer comprising carboxyl repeating units, 1,4-dicarboxyl benzene, 1,3-dicarboxyl benzene, 1,2-dicarboxyl benzene, 1,3,5-tricarboxyl benzene, naphthalene comprising 3 carboxyl groups, and anthracene comprising 3 carboxyl groups, and wherein 1,4-dicarboxyl benzene, 1,3-dicarboxyl benzene, 1,2-dicarboxyl benzene, 1,3,5-tricarboxyl benzene, naphthalene, and anthracene can be substituted or non-substituted.

5. The data storage device of claim 1, wherein the crystalline cationic multimetallic transition metal complex salt is configured to release oxygen at a temperature greater than about 50° C., and wherein the crystalline cationic multimetallic transition metal complex salt is configured to store oxygen at a temperature below about 30° C.

6. The data storage device of claim 1, wherein m is one, and R1-COOH is selected from the group consisting of: methyl, phenyl, choloromethyl, dicholoromethyl, tricholoromethyl, and ethylsulfide.

7. The data storage device of claim 1, wherein the counteranion and R1 are selected to determine an oxygen releasing speed and an oxygen releasing temperature.

8. The data storage device of claim 1, wherein m is two, and R1-COOH is selected from the group consisting of: non-substituted and substituted 1,4-dicarboxyl benzene, 1,3-dicarboxyl benzene, or 1,2-dicarboxyl benzene, wherein when substituted, the substitution is selected from the group consisting of: F, Cl, NH₂, alkyl, carbonyl, and a combination thereof.

9. The data storage device of claim 1, wherein m is three, and R1-COOH is selected from the group consisting of: non-substituted and substituted 1,3,5-tricarboxyl benzene, naphthalene comprising 3 carboxyl groups, and anthracene comprising 3 carboxyl groups, wherein when substituted, the substitution is selected from the group consisting of: F, Cl, NH₂, alkyl, carbonyl, and a combination thereof.

10. The data storage device of claim 1, wherein m is greater than or equal to 4, and wherein R1-COOH is a polymer comprising carboxyl repeating units.

11. The data storage device of claim 1, wherein the crystalline cationic multimetallic transition metal complex salt further comprises at least one inorganic material selected from the group consisting of: permanganates, peroxides, percarbonates, and combinations thereof.

12. The data storage device of claim 1, further comprising an oxygenating system.

13. The data storage device of claim 12, wherein:
the crystalline salt is inside a cell inside a sealed casing of the data storage device;
an oxygen permeable membrane covers an opening in the cell;
the cell is an oxygen permeable membrane pouch;
the oxygen permeable membrane comprises at least one of polytetrafluoroethylene (PTFE), low density polyethylene, high density polyethylene, ethylene vinyl acetate, polyurethane, polyvinyl alcohol, or isoprene rubber; and
the cell is gas-impermeable and comprises at least one of aluminum, steel, nickel, zinc or plastic.

14. An oxygenating material for treating an atmosphere of a magnetic storage device, the oxygenating material comprising:
a counteranion selected from the group consisting of: perchlorate (ClO₄—), tetrafluoroborate (BF₄—), hexafluorophosphate (PF₆—), trifluoromethanesulfonate (CF₃SO₃—), sulfate, halides, chloride, bromide, fluoride, iodide, astatine, nitrate, thiocyanate, acetate, carbonate, selenite, oxalate, phosphate, thiosulfate, silicate, metasilicate, chromate, dichromate, permanganate, citrate, cyanide, nitrite, chlorate, antimonite hexachloro-antimonate, hexafluoro antimonate, arsenate, arsenite, molybdenum, hexafluorosilicate, and aluminate; and 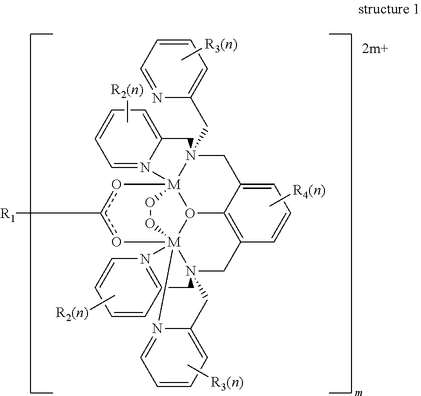
wherein M is selected from the group consisting of: Go, Ni, Mn, Fe, and Cu,
wherein n is an integer between 0 and 4,
wherein m is an integer between 1 and 100, m being the number of repeating units of structure 1,
wherein R1-COOH is selected from the group consisting of: methyl, phenyl, choloromethyl, dicholoromethyl, tricholoromethyl, ethylsulfide, a polymer comprising carboxyl repeating units, 1,4-dicarboxyl benzene, 1,3-dicarboxyl benzene, 1,2-dicarboxyl benzene, 1,3,5-tricarboxyl benzene, naphthalene comprising 3 carboxyl groups, and anthracene comprising 3 carboxyl groups, and
wherein 1,4-dicarboxyl benzene, 1,3-dicarboxyl benzene, 1,2-dicarboxyl benzene, 1,3,5-tricarboxyl benzene, naphthalene, and anthracene can be substituted or non-substituted.

15. The oxygenating material of claim 14, wherein one or more of R2, R3, and R4 is selected from the group consisting of: F, Cl, Br, I, CH₃, ethyl, propyl, n-butyl, tert butyl, carbonyl, carboxyl, hydroxyl, alkyl, aryl, amine, amide, and nitro.

16. The oxygenating material of claim 14, wherein M is Co, and wherein the counteranion and R1-COOH are selected to determine an oxygen releasing speed and an oxygen releasing temperature.

17. The oxygenating material of claim 14, wherein the oxygenating material is configured to release oxygen at a temperature greater than about 50° C., and wherein the oxygenating material is configured to store oxygen at a temperature below about 30° C.

18. The oxygenating material of claim 14, wherein m is one, and R1-COOH is selected from the group consisting of: methyl, phenyl, choloromethyl, dicholoromethyl, tricholoromethyl, and ethylsulfide.

19. The oxygenating material of claim 14, wherein the oxygenating material is configured to release oxygen at a speed that maintains a level of oxygen between about 8% to about 12% of an atmosphere of the data storage device.

20. The oxygenating material of claim 14, wherein m is two, and R1-COOH is selected from the group consisting of: non-substituted and substituted 1,4-dicarboxyl benzene, 1,3-dicarboxyl benzene, or 1,2-dicarboxyl benzene, wherein when substituted, the substitution is F, Cl, Br, I, carbonyl, carboxyl, hydroxyl, alkyl, aryl, amine, amide, nitro, or a combination thereof.

21. The oxygenating material of claim 14, wherein m is three, and R1-COOH is selected from the group consisting of: non-substituted and substituted 1,3,5-tricarboxyl benzene, naphthalene comprising 3 carboxyl groups, and anthracene comprising 3 carboxyl groups, wherein when substituted, the substitution is selected from the group consisting of: F, Cl, Br, I, carbonyl, carboxyl, hydroxyl, alkyl, aryl, amine, amide, nitro, and a combination thereof.

22. The oxygenating material of claim 14, wherein m is greater than or equal to 4, and wherein R1-COOH is a polymer comprising a carboxyl repeating unit.

23. The oxygenating material of claim 14, wherein the crystalline salt is configured to constantly release oxygen when heated to above about 50° C.

24. The oxygenating material of claim 14, wherein the oxygenating material comprises at least one organic oxygen releaser to control an oxygen releasing profile in the magnetic storage device.

25. The oxygenating material of claim 14, wherein the oxygenating material is mixed together with one or more desiccants.

26. An oxygenating system comprising the oxygenating material of claim 14.

27. The oxygenating system of claim 26, wherein:
the oxygenating material is inside a cell inside a sealed casing of the magnetic storage device; and
an oxygen permeable membrane covers an opening in the cell.

28. The oxygenating system of claim 27, wherein the oxygen permeable membrane comprises at least one of polytetrafluoroethylene (PTFEI, low density polyethylene, high density polyethylene, ethylene vinyl acetate, polyurethane, polyvinyl alcohol, or isoprene rubber, and wherein the cell is gas-impermeable or gas-permeable and comprises at least one of aluminum, steel, nickel, zinc or plastic.

29. The oxygenating system of claim 26, wherein the oxygenating material is in the form of a powder or tablets.

30. The oxygenating system of claim 26, wherein the oxygenating material is coated on zeolites or nanotubes.
